(19) United States
(12) Patent Application Publication
(10) Pub. No.: US 2026/0291255 A1
(43) Pub. Date: Sep. 24, 2026

(54) Combining Newton-Raphson and Preconditioned Conjugate Gradient for Power Flow Analysis of Hybrid AC/DC Power Systems

(71) Applicant: Mitsubishi Electric Research Laboratories, Inc., Cambridge, MA (US)

(72) Inventors: Hongbo Sun, Lexington, MA (US); Deepi Singh, New York, NY (US)

(73) Assignee: Mitsubishi Electric Research Laboratories, Inc., Cambridge, MA (US)

(21) Appl. No.: 19/083,819

(22) Filed: Mar. 19, 2025

(51) Int. Cl. H02J 4/00; H02J 3/38

(52) U.S. Cl. CPC H02J 4/00; H02J 3/381; H02J 2101/20; H02J 2103/30; H02J 2103/35

(57) ABSTRACT

A method for performing power flow analysis in a hybrid AC/DC power system includes linearizing nonlinear power flow equations of the hybrid AC/DC power system using a Newton-Raphson (NR) method to generate a sparse Jacobian matrix, a mismatch vector and a set of initial state variables. The method also includes iteratively solving the linearized equations using a Preconditioned Conjugate Gradient (PCG) method with trust region constraint. The PCG method leverages the sparsity of the Jacobian matrix to efficiently compute updates to state variables. Also, a preconditioner is applied to improve the numerical stability and convergence of the PCG method. The method further includes refining the solution iteratively by feeding the updated state variables back into the NR method until convergence criteria are met to produce a result of the power flow analysis. Moreover, the method includes controlling the power system based on the result of the power flow analysis.

### TECHNICAL FIELD

This disclosure relates generally to power systems and more particularly to power flow analysis of Hybrid AC/DC power systems.

### BACKGROUND

The field of power flow analysis is undergoing significant evolution due to the increasing complexity of modern power systems. The integration of hybrid AC/DC networks, distributed energy resources (DERs), and renewable energy sources has introduced unprecedented challenges in ensuring accurate, efficient, and robust power flow solutions. Traditional methods, while effective in simpler systems, face severe limitations in scalability, robustness, and efficiency when applied to large-scale, ill-conditioned networks with dynamic and nonlinear interactions.

Traditional methods for power flow analysis, such as the Newton-Raphson (NR) method, provide reliable accuracy but suffer from computational inefficiencies in large-scale systems. The reliance on direct solvers for handling linearized equations results in significant memory and computational burdens due to the dense factorization of sparse Jacobian matrices. Additionally, hybrid AC/DC networks introduce complex interactions between alternating current (AC) and direct current (DC) systems, requiring methods that can handle non-linearities, dynamic control modes, and scalability. Sequential and unified load flow methods, while addressing specific aspects of these challenges, fail to provide a robust, scalable, and efficient solution for next-generation power grids.

### SUMMARY

Some embodiments are based on the recognition that the computational inefficiencies and scalability issues in power flow analysis stem from the reliance on direct solvers for large, sparse systems generated during Newton-Raphson (NR) iterations. By observing that iterative solvers such as the Preconditioned Conjugate Gradient (PCG) method are inherently efficient for sparse systems, the disclosure provides for leveraging the complementary strengths of NR and PCG. Specifically, the sparse nature of the Jacobian matrix in NR iterations makes it highly suitable for iterative solvers.

Accordingly, the object of the disclosure is to provide a scalable and robust framework for performing power flow analysis for a hybrid AC/DC power system by combining NR for its accurate nonlinear predictions with PCG for efficiently solving linearized subproblems and subsequently control the hybrid AC/DC power system based on the results/output of the power flow analysis.

The recognition of the sparse structure of the Jacobian matrix and the suitability of PCG for handling such systems led to a paradigm shift in how power flow problems are approached. By replacing direct solvers with PCG, the computational burden associated with dense matrix factorization was eliminated. Furthermore, integrating preconditioning techniques improved the numerical stability and convergence rate of PCG, enabling the method to handle ill-conditioned and highly nonlinear systems effectively. This approach also allowed for seamless scalability, making the approach suitable for large-scale hybrid AC/DC networks with distributed energy resources and renewable energy integration.

The disclosure provides a hybrid framework that combines NR and PCG within a unified trust-region approach. The method involves using NR to provide an accurate initial guess for state variables and generate a sparse Jacobian matrix. The PCG method is then applied to iteratively solve the linearized equations, leveraging the sparsity of the Jacobian for computational efficiency. Preconditioning techniques, such as diagonal preconditioning or incomplete LU factorization, are employed to enhance the convergence of PCG. Additionally, the method dynamically switches to alternative methods, such as line search, if PCG fails to converge within specified iteration limits, ensuring robustness under challenging conditions.

By combining the nonlinear solving capabilities of NR with the efficiency of PCG, the approach achieves a balance between accuracy and computational efficiency. The technique or the method enables robust and scalable solutions for large-scale hybrid AC/DC networks, addressing challenges such as ill-conditioned systems, dynamic interactions, and renewable energy integration. The framework is well-suited for real-time applications, operational planning, and contingency analysis, significantly advancing the state of the art in power system analysis.

Another embodiment discloses a method for performing power flow analysis in a hybrid AC/DC power system. The method includes linearizing nonlinear power flow equations of the hybrid AC/DC power system using a Newton-Raphson (NR) method to generate a sparse Jacobian matrix, a mismatch vector and a set of initial state variables. The method also includes iteratively solving the linearized equations using a Preconditioned Conjugate Gradient (PCG) method, wherein: the PCG method leverages the sparsity of the Jacobian matrix to efficiently compute updates to state variables; and a preconditioner is applied to improve the numerical stability and convergence of the PCG method. The method further includes refining the solution iteratively by feeding the updated state variables back into the NR method until convergence criteria are met to produce a result of the power flow analysis. Moreover, the method includes controlling the power system based on the result of the power flow analysis.

Yet another embodiment discloses a system for performing power flow analysis in a power system. The system includes a processor configured to execute instructions to: (i) linearize nonlinear power flow equations and finding an initial state using a Newton-Raphson (NR) method; (ii) solve the linearized equations using a Preconditioned Conjugate Gradient (PCG) method with a preconditioner; and (iii) dynamically switch to a line search method if the PCG method fails to converge. The system also includes a memory storing instructions and parameters for the NR and PCG methods, including preconditioner definitions, convergence thresholds, and system topology information. Further, the system includes a controller configured to control the power system based on the power flow analysis and using the instructions and parameters stored in the memory.

### BRIEF DESCRIPTION OF THE DRAWINGS

FIG. 1A shows a method for power flow analysis of hybrid AC/DC power systems.

FIG. 1B shows a schematic of a method for dynamically switching to a line search method from PCG method for power flow analysis of hybrid AC/DC power systems.

FIG. 2 shows a schematic of flowchart of the proposed Adaptive Hybrid Prediction-Correction with Trust-Region and Dynamic Line Search (AHPC-TRDLS) method for power flow analysis of hybrid AC/DC power systems.

FIG. 3A shows a schematic an example hybrid AC/DC power system/network.

FIG. 3B shows a schematic of an example AC/DC interfacing converter with RL filter used in the hybrid AC/DC power system of FIG. 3A.

FIG. 4 shows a table listing different types of nodes in hybrid AC/DC networks and corresponding known and unknown variables.

FIG. 5 shows a schematic of computing device that is representative of any system or collection of systems in which the various processes, programs, services, and scenarios of some embodiments disclosed herein are implemented.

FIG. 6 shows a schematic of 6-Bus hybrid AC/DC system.

FIG. 7 shows a schematic of bus voltages of the system of FIG. 6 determined under balanced conditions by using the proposed AHPC-TRDLS method.

FIG. 8 shows a schematic of bus voltages of the system of FIG. 6 determined under unbalanced conditions by using the proposed AHPC-TRDLS method.

FIG. 9 shows a schematic of bus voltages of the system of FIG. 6 under condition with one bus voltage fallen below lower threshold by using the proposed AHPC-TRDLS method.

### DETAILED DESCRIPTION

### Overview of the Contribution to the Art

This overview is provided to introduce a selection of concepts in a simplified form that are further described below in the Detailed Description. This overview is not intended to identify key features or essential features of the claimed subject matter, nor is it intended to be used as an aid in determining the scope of the claimed subject matter.

Power flow analysis (also known as load flow analysis) is used in power systems to determine the voltage, current, active power, reactive power, and power factor throughout the system. Power flow analysis is essential operation, and optimization of electrical networks, ensuring that power is transmitted effectively and reliably from generation sources to consumers.

The power flow analysis for an hybrid AC/DC systems presents several unique challenges due to the differences in operating principles, control strategies, and the complexities introduced by combining AC and DC networks. The key challenge is the nonlinear and dynamic interactions between the AC and DC sides, as well as the converters used to interface between AC and DC networks.

With hybrid AC/DC systems, power flow analysis faces scalability issues, especially when using traditional iterative methods like Newton-Raphson. This is due to the fact that Jacobian matrix in Newton-Raphson (NR) iterations for power flow analysis is large-scale but sparse for practical power systems. This is due to the fact the Jacobian matrix reflects the topology of the power network and the localized nature of interactions between its components. For example: the topology of the power system is such that each bus is directly connected to only a few neighboring buses through transmission lines. These connections define the system's admittance/Jacobian matrix, which is sparse because most buses are not directly connected to one another. Also, the Jacobian matrix in NR is derived from the partial derivatives of power flow equations (active and reactive power, and voltage if appliable) with respect to state variables (voltage magnitudes and angles). Each row in the Jacobian corresponds to a specific bus, and non-zero entries exist only for the bus itself and neighboring buses directly connected by transmission lines.

It has been recognized that the computational inefficiencies and scalability issues in power flow analysis stem from the reliance on direct solvers for large, sparse systems generated during NR iterations. To overcome this challenge, the method and system of the present disclosure utilizes the Preconditioned Conjugate Gradient (PCG) method, an iterative solver, which is inherently efficient for sparse systems, the inventor identified an opportunity to leverage the complementary strengths of specifically, the sparse nature of the Jacobian matrix in NR iterations makes the Jacobian matrix highly suitable for iterative solvers. Accordingly, current disclosure provides for combining NR for its accurate nonlinear predictions with PCG for efficiently solving linearized subproblems could provide a scalable and robust framework for power flow analysis of hybrid AC/DC system and control the hybrid AC/DC power system.

By replacing direct solvers with PCG, the computational burden associated with dense matrix factorization was eliminated. Furthermore, integrating preconditioning techniques improved the numerical stability and convergence rate of PCG, enabling the method to handle ill-conditioned and highly nonlinear systems effectively. This approach also allowed for seamless scalability, making the method suitable for large-scale hybrid AC/DC networks with distributed energy resources and renewable energy integration. The framework is well-suited for real-time applications, operational planning, and contingency analysis, significantly advancing the state of the art in power system analysis.

The method and system of the disclosure combines NR and PCG within a unified trust-region approach. The method includes using NR to provide an accurate initial guess for state variables and generate a sparse Jacobian matrix. Thereafter, the method includes applying PCG method to iteratively solve the linearized equations, leveraging the sparsity of the Jacobian for computational efficiency. Preconditioning techniques, such as diagonal preconditioning or incomplete LU factorization, are employed to enhance the convergence of PCG. Additionally, the method dynamically switches to alternative methods, such as line search, if PCG fails to converge within specified iteration limits, ensuring robustness under challenging conditions.

Accordingly, the method and system includes an adaptive Hybrid Prediction-Correction with Trust-Region and Dynamic Line Search (AHPC-TRDLS). Trust-region method is utilized to limit the step size of iterations to ensure stable convergence. By incorporating adaptive step size control, trust-region-based correction, and PCG with line search fallback, the method addresses the limitations of conventional prediction-correction frameworks. The method's ability to handle ill-conditioned networks, weak grids, and large-scale systems ensures reliable performance under various scenarios. This hybrid approach, with its preconditioning based on Jacobian condition number, provides a balance between accuracy and computational efficiency. Due to method's versatility, the method is applicable to hybrid AC/DC systems with VSC-HVDC links and operational challenges, such as unbalanced conditions and high R/X ratios.

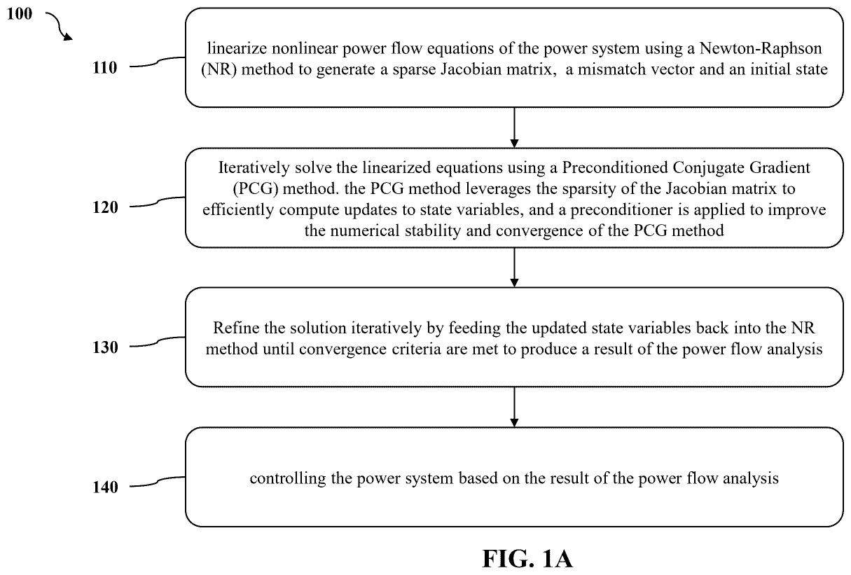

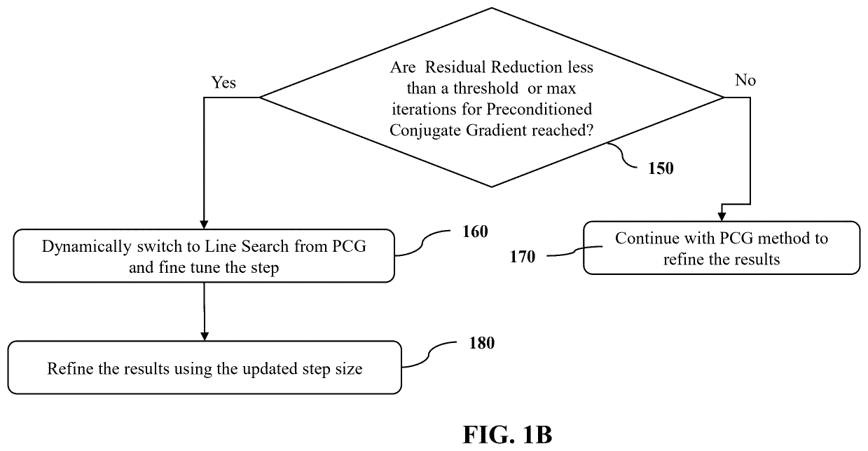

Referring to FIG. 1A, a method 100 for performing a power flow analysis for a hybrid AC/DC power system and controlling the hybrid AC/DC power system is disclosed. The method 100 includes a step 110, at which a processor is arranged in communication with various components, for example, buses, power generators, voltage source converters, etc., of the hybrid AC/DC power system, and determines the power flow equations of the power system and linearize the nonlinear power equations of the power using the Newton-Raphson method, and generates a sparse jacobian matrix. In some embodiments, the processor generates or determines the nonlinear power equations for the active power and reactive power for each bus of the power system. The active power and the reactive power, each is represents as a relationship between admittance matrix, voltage magnitudes, and voltage phase angles between the adjacently arranged buses. In some embodiments, for linearizing the power flow equations, the Newton-Raphson method set initial guesses for the voltage magnitudes and angles at all buses, and determine power mismatch vector for each bus of the power system. The mismatch vector for each bus is a difference between the calculated and specified active power, and calculated and specified reactive power. The Jacobian matrix is determined/generated based on the active and reactive power equations of the power system. For so doing, in some embodiments, the Jacobian matrix relates to changes in the voltage magnitudes and phase angles to changes in the power mismatches. Jacobian matrix is derived from the partial derivatives of the power flow equations with respect to the voltage magnitude and phase angle for each bus. Also, in some embodiments, Jacobian matrix is generated by incorporating the voltage source (VSC) control modes of voltage source converters of the power system.

Upon determining sparse Jacobian matrix and the mismatch vector i.e., mismatch for specified and calculated active power and mismatch between specified and calculated reactive power, the processor, at a step 120, of the method 100, iteratively solve the linearized equation i.e., sparse Jacobian matrix, using the PCG method. For solving the Jacobian sparse matrix and improving the numerical stability and converge of the PCG method, a preconditioner is applied. In some embodiments, the preconditioner is a diagonal preconditioner. However, other known preconditioner, such as, but not limited, incomplete LU decomposition, block preconditioner may also be used. For solving the sparse Jacobian matrix, in embodiments, the processor may initialize the PCG method by choosing/guessing an initial value of state variables, for example, voltage magnitudes, phase angles, etc., and determine an initial residual. In the embodiments, the PCG method includes determining a step size using initial residual and the preconditioner, and determines updated state variables using the step size.

In some embodiments, PCG method is applied within a trust-region framework. Accordingly, in some embodiments, the processor checks the updated state variable, computed, using the PCG method, against a trust region constraint to ensure that the updated state variables remain within a bounded region. In some embodiments, the trust-region constraint is represented by the norm of the updates being less than a radius of the trust region. Accordingly, the trust region framework refines the state variables by solving the linearized equations more accurately, ensuring the solution stays within the specified trust-region radius. In some embodiments, the updates to state variables are scaled back using a scaling factor defined as the ratio of the radius of trust region to the norm of the updates at the current step, if the constraint is violated.

In some embodiments, the radius of trust region is dynamically updated/reduced for stability If the step size exceeds the trust region or convergence slows down. In some embodiments, the radius of the trust region is updated based on the effectiveness index of updates for state variables determined using the PCG method, relative to the initial state generated using the NR method. if the effectiveness index is less than the acceptance threshold, the radius is halved compared to value of the radius at the current step to ensure better control in subsequent iterations. Otherwise, the radius is scaled up to the minimum of either twice the current radius or an upper threshold for the step size.

In some embodiments, the effectiveness index is defined as the ratio of the difference between the norm of the mismatch vector (computed using the updated state variables determined using PCG method) and the norm of the mismatch vector (computed using the initial state variables that are determined using NR method), to the norm of the initial state generated using the NR method. The updated state variables are derived from the initial state variables computed using the NR method and updated with the PCG method.

The method 100 also includes a step 130 at which the processor refines the solutions by using the updated states variable and feeding the updated state variables into the Newton-Raphson method and then PCG method to update the state variables further to keep reducing the residual. The process is iteratively repeated until a convergence criteria is met to produce the results of the power flow analysis. In some embodiments, the convergence criteria a threshold for the mismatch vector norm and operational constraints such as voltage magnitude limits and reactive power bounds. The results includes the voltage magnitude, voltage phase angles, the active power, reactive power, at each bus, to enable a control of the power system i.e, to control, the switches, the taps, etc., of the power system to balance load of the power system and flow of power between the AC networks and DC networks.

In some embodiments, the convergence criterion includes a threshold for the mismatch vector norm and operational constraints such as voltage magnitude limits and reactive power bounds.

Also, in some embodiments, the iteration limit of the PCG reaches without meeting the convergence criteria or PCG fails to reduce residual sufficiently. In such a case, the method switches to an alternative solving technique from PCG, for example, a line search method. This dynamic line search fine-tunes/adjust the step size, ensuring the solution stays within feasible bounds and maintains convergence. The hybrid approach of switching between PCG and line search allows the method, i.e., processor to handle challenging conditions, such as ill-conditioned systems or highly unbalanced power flows.

Thereafter, the method 100 includes a step 140 at which the processor control hybrid AC/DC power system using outputted load flow results.

In some embodiments, when unbalanced conditions exists, the method decomposes three-phase voltages and currents into positive, negative, and zero sequences using symmetrical components. This decomposition allows for independent analysis of each sequence, improving the method/system ability to manage unbalanced load flows. This feature is crucial for systems with renewable energy sources and variable loads.

By utilizing the above method, bus voltage adjustments and converter operations are managed cohesively, ensuring seamless interactions between AC and DC buses. The method also enforces operational constraints by switching between PQ and PV control modes, ensuring that voltage and reactive power limits are maintained.

The method facilitates in continuously monitoring voltage magnitudes and reactive power across buses and converters. If limits are exceeded, the method provides for automatically switching between PQ control mode (active and reactive power control mode) and PV control mode (voltage and active power control mode) of voltage source converters, ensuring that the system operates within safe boundaries. This mechanism ensures stability, even under dynamic grid conditions with fluctuating power.

FIG. 1B shows a schematic of a method for dynamically switching to a line search method from PCG method. The method includes a step 150 at which the processor determines/check if the iteration limit of the PCG reaches without meeting the convergence criteria or PCG fails to reduce residual sufficiently. The method moves to a step 160 either the iteration limit of the PCG reaches without meeting the convergence criteria or PCG fails to reduce residual sufficiently, else the method moves to step 170 at which the processor continue to use PCG method to iteratively update the results of voltage and powers. At the step 160, the processor dynamically switch the to line search method to adjust the step size and then uses the new step size to update the results of voltages and powers, at the step 180. Thereafter, the processor calculates a mismatch/residual and updated the results based on new step size and iteratively solve the Jacobian matrix using NR method and PCG method until convergence criterion are met.

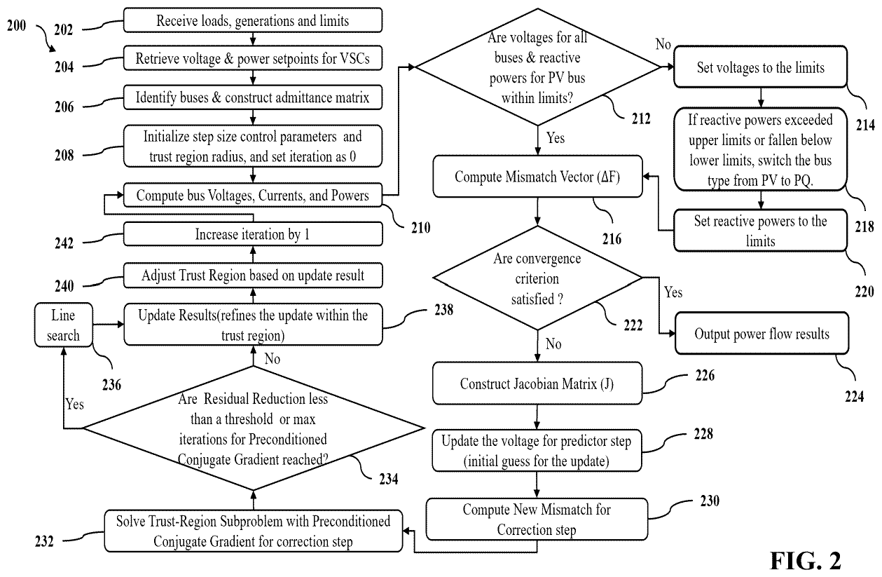

Referring to FIG. 2, a method 200 for performing power flow analysis and corresponding method for controlling a hybrid AC/DC power grid, according to some embodiments, is shown. The method includes a step 202 at which a processor retrieves/receives loads, generation capacities, and limits of power generators of the AC/DC hybrid power system. The method also includes a step 204 at which the processor collects/retrieves voltage and power setpoints of the VSCs of the power system. Further, the method includes a step 206 at which the processor determines/identifies the buses of the system and determines operating points and limits of the buses.

Upon collecting the necessary data, the method includes a step 208 at which the processor constructs an admittance matrix for the power system. The admittance matrix represents the power flow equations of the power system and is fundamental in analyzing the system's behavior, including voltage and current distribution. The admittance matrix reflects the admittance (the inverse of impedance) between buses in the system.

Thereafter, the method moves to a step 208 at which the processor set the step size control parameters, and trust region radius for solving the admittance matrix using Newton-Raphson method. Subsequently, the processor, at a step 210 of the method, predict/estimates/computes initial state variables, for example, voltages, currents, and powers i.e., active and reactive powers of the buses using Newton-Raphson method. Upon calculating/predicting initial state variables, the method at a step 212 checks/determines if the estimated voltages for all buses and estimated reactive powers for PV buses (generator buses) is within limits. A PV bus refers to a type of bus where both the active power and voltage magnitude are specified, but the reactive power is determined through the power flow calculation. The method moves to a step 214 if the estimated voltages of all the buses and/or the estimated reactive power of PV buses are outside the limits, else the method moves to a step 216.

At the step 214 of the method, the processor set voltages of the all buses to respective limits. Thereafter, the processor, at a step 218, switch the bus type from PV to PQ (load bus) upon determination that reactive powers of the PV buses have exceeded upper limits or fallen below the lower limits, and thereafter set the reactive powers of the buses to the respective limits, at a step 220 of the method. Thereafter the method moves to the step 216. A PQ bus in power system analysis is a type of bus where both active power and reactive power are known, while the voltage magnitude (V) and voltage angle (θ) are calculated during power flow analysis.

At the step 216 of the method, the processor compute mismatch vector (ΔF), and determines, at a step 222, if convergence criterion are satisfied. The method moves to a step 224 if the convergence criterion are satisfied, else the method moves to a step 226. At the step, the processor output power flow results, and control the power system based on the power flow results. In embodiments, the convergence criterion includes a threshold for the mismatch vector norm and operational constraints such as voltage magnitude limits and reactive power bounds.

At the step 226, the processor constructs a Jacobian matrix from the admittance matrix or power flow equations, and updates the initial state variables, for example the bus voltages, current, and powers, at a step 228 of the method. In the embodiments, the processor updates the initial state variables by solving the Jacobian matrix using NR method. Upon determining the updated state variables, for example, the bus voltages, current, and powers, processor computes a new mismatch/residual, at step 230. Thereafter, at step 232 of the method, the processor applies PCG method with trust region and using step size control to the Jacobian matrix to calculate/correct state variables, for example, bus voltages, current, and powers to reduce mismatch. Upon correcting/updating the state variables, the processor, at a step 234, determines/check whether the residual/mismatch reduction is less than a threshold value or maximum iteration for applying the PCG method has reached.

The method moves to step 236 if the residual reduction is less than the threshold value or maximum iteration for applying the PCG method has reached, else the method moves to a step 238. At the step 236 of the method, processor uses/applies a line search method to fine tune the step size and using the line search method, and the method moves to the step 238. Thereafter, the method update the state variables, for example, the bus voltages, current, and powers, within the trust region and moves to a step 240. At step 240, the processor adjusts the trust region based in the updated results, and increase the PCG iteration by 1 at a step 242 of the method. Thereafter, the method moves to the step 210 to recalculate the state variables, for example, the bus voltages, powers, and currents. These iterations to update the state variables continues till the convergence criterion are met. Upon receiving the power flow results, the controller or processor controls the power system parameters including voltage, active and reactive power flows, frequency, and the exchange of power between the AC and DC grids based on the power flow results to ensure the system operates efficiently, stably, and within limits.

In this manner, the processor utilizes, Newton-Raphson method, PCG within the trust region framework, and the line search to iteratively determines the power flow results that are then used to control the power system. Designed for high scalability, the method manages large, multi-terminal hybrid AC/DC systems efficiently. The PCG method with diagonal preconditioning allows the method to handle large, sparse matrices typical in power flow analysis. Scalability of the method makes it suitable for multi-terminal systems with complex operational constraints and dynamic control modes. The method seamlessly integrates VSCs, HVDC links, and DERs, making the method applicable to both transmission and distribution networks managed by Independent System Operators (ISOs) and Distribution System Operators (DSOs).

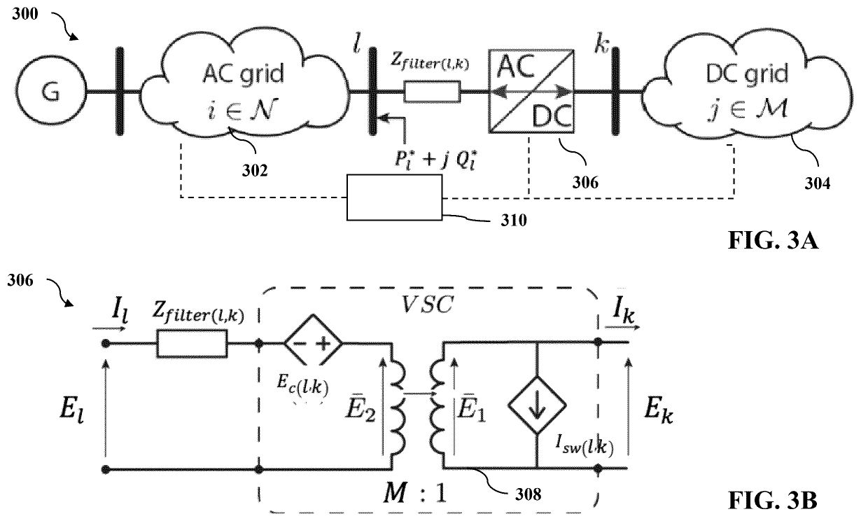

Referring to FIG. 3A, shows a schematic of an example hybrid AC/DC power system 300. The power system 300 includes three parts, an AC network 302, a DC network 304, and the interfacing converters (ICs) 306. i∈N, and j∈M. N and M are the sets of AC nodes and DC nodes. (l, k)∈Γ′, where l∈N and k∈M. Γ is the set of coupled buses of interfacing converters (ICs). Assume the AC network is a grounded system, and the DC network is monopolar. Both the AC and DC networks can include multiple sub-systems, each isolated within the same type of system but interconnected with sub-systems of the other type.

FIG. 3B shows a schematic of the AC/DC interfacing converter 306 with RL filter, 308. Its conduction losses are modelled as a voltage source on the AC side, and its switching losses as a DC current source.

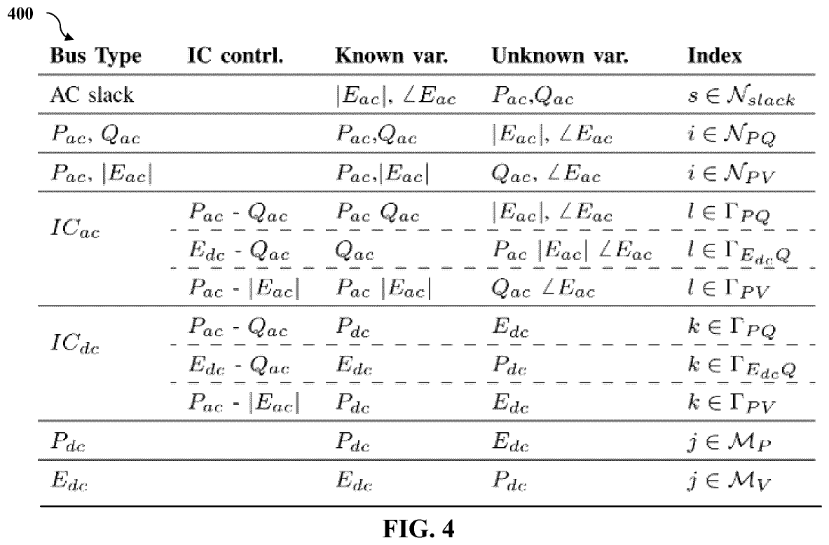

FIG. 4 provides a table 400 that lists all node types and associated known and unknown variables in a hybrid AC/DC power system 300. As shown in FIG. 4, the AC network 302 consists of three types of buses/nodes: Slack nodes N_{slack}, PV nodes N_{PV}, and PQ nodes N_{PQ}, and the DC network 304 includes P nodes M_{P} and V nodes M_{V}. The IC model is dependent on the converter's operational mode. Typically, VSCs allows the control of two variables simultaneously: Edc−Qac, Pac−Qac and Pac−|Eac|, and accordingly the sets of interfacing converters operated at such modes are represented as Γ_{E}_{_{dc}}_{Q} (i.e. set of VQ modes), Γ_{PQ} (i.e. set of PQ modes), and Γ_{PV} (i.e. set of PV modes). Pac and Qac represent the active and reactive powers of AC Node, Edc is the voltage of DC node, |Eac| and ∠Eac are the voltage magnitude and phase angle of AC node. Based on the above, a processor 310 of the power system 300, determines the power flow equations, as described below.

### AC Network Power Flow Equations

For a PQ bus in AC network, its power flow equations can be described as:

$$Re ( {E}_{i}^{{ϕ}_{i}} {\sum }_{{ϕ}_{n} ∈ {Φ}_{n} , n ∈ N} conj ( {Y}_{a c ( i , n )}^{{ϕ}_{i} , {ϕ}_{n}} {E}_{n}^{{ϕ}_{n}} ) ) = {P}_{i}^{{ϕ}_{i} *} , for i ∈ {N}_{PQ} , {ϕ}_{i} ∈ {Φ}_{i} \qquad ( 1 )$$

$$Im ( {E}_{i}^{{ϕ}_{i}} {\sum }_{{ϕ}_{n} ∈ {Φ}_{n} , n ∈ N} conj ( {Y}_{a c ( i , n )}^{{ϕ}_{i} , {ϕ}_{n}} {E}_{n}^{{ϕ}_{n}} ) ) = {Q}_{i}^{{ϕ}_{i} *} , for i ∈ {N}_{PQ} , {ϕ}_{i} ∈ {Φ}_{i} \qquad ( 2 )$$

$$Re ( {E}_{i}^{{ϕ}_{i}} {\sum }_{{ϕ}_{n} ∈ {Φ}_{n} , n ∈ N} conj ( {Y}_{a c ( i , n )}^{{ϕ}_{i} , {ϕ}_{n}} {E}_{n}^{{ϕ}_{n}} ) ) = {P}_{i}^{{ϕ}_{i} *} , for i ∈ {N}_{PV} , {ϕ}_{i} ∈ {Φ}_{i} \qquad ( 3 )$$

$$\vert {E}_{i}^{{ϕ}_{i}} \vert = \vert {E}_{i}^{{ϕ}_{i} *} \vert , for i ∈ {N}_{PV} , {ϕ}_{i} ∈ {Φ}_{i} \qquad ( 4 )$$

where Re(⋅), Im(⋅), conj(⋅) and |⋅| denote the real part, imaginary part, conjugate and absolute value of a complex number.

$${P}_{i}^{{ϕ}_{i}} , {Q}_{i}^{{ϕ}_{i}} and {E}_{i}^{{ϕ}_{i}}$$

are the active power injection, reactive power injection and phase-to-ground voltage at node i and phase φᵢ, respectively. Φᵢ ∈{a, b, c} is the set of phases at node i.

$${Y}_{a c ( i , n )}^{{ϕ}_{i} , {ϕ}_{n}}$$

is the element of AC network admittance matrix in phase domain corresponding to node i phase φᵢ, and node n phase φₙ.

$${P}_{i}^{{ϕ}_{i} *} , {Q}_{i}^{{ϕ}_{i} *} and \vert {E}_{i}^{{ϕ}_{i} *} \vert$$

are the specified values of

$${P}_{i}^{{ϕ}_{i}} , {Q}_{i}^{{ϕ}_{i}} and \vert {E}_{i}^{{ϕ}_{i}} \vert .$$

### DC Network Power Flow Equations

$${E}_{j} = {E}_{j}^{*} , for j ∈ {M}_{V} \qquad ( 6 )$$

where Eⱼ and Pⱼ are voltage and power injection of node j. Y_{dc(j,m)} represents the element of DC network admittance matrix corresponding to node j and node m, and

$${E}_{j}^{*} and {P}_{j}^{*}$$

are the specified values of Eⱼ and Pⱼ, respectively.

### Interfacing Converter Power Flow Equations

As shown in FIG. 3B, assuming that the semiconductor switches of the VSCs are Insulated-Gate Bipolar Transistors (IGBT), the losses of the AC/DC interfacing converter, S_{loss(l,k)} can be sum of a conduction losses modelled as a voltage source on the AC side, E_{c(l,k)} and a switching loss modeled as a DC current source I_{sw(l,k)}:

$${S}_{loss ( l , k )} = {E}_{c ( l , k )} {I}_{l} + {I}_{sw ( l , k )} {E}_{k} \qquad ( 7 )$$

where Iₗ is the current flowing from node l toward node k through branch (l, k), E_{c(l,K)}=R_{eq} (|Iₗ|,

$${I}_{l} = {\sum }_{{ϕ}_{n} ∈ {Φ}_{n} , n ∈ N} {Y}_{a c ( l . n )}^{{ϕ}_{i} , {ϕ}_{n}} {E}_{n}^{{ϕ}_{n}} ,$$

$${I}_{sw ( l , k )} = 2 \frac{{T}_{ON} + {T}_{OFF} + {T}_{REC}}{{T}_{sw}} \frac{1}{N} cot ( \frac{π}{N} ) \vert {I}_{l} \vert ,$$

R_{eq} is the equivalent resistance of the IGBT varied with |Iₗ|, T_{sw} is the switching period, and N=f_{sw}/f_{grid} is the ratio between the converter's switching frequency f_{sw} and the grid frequency f_{grid}. T_{ON} and T_{OFF} are the equivalent time commutation constants characterizing the transistor's turn-on and turn-off effects under the test conditions, and T_{REC} is the reverse recovery at turn-off of the diode. The losses over the RL-filter with impedance Z_{filter(l,k)}, S_{filter(l,k)} can be determined as:

$${S}_{filter ( l , k )} = {Z}_{filter ( l , k )} {\vert {I}_{l} \vert}^{2} , \qquad ( 8 )$$

Besides the phase domain, phase sequences are also used in this disclosure to express the converter control mechanism. In this disclosure, the superscript “+”, “−”, and “0” indicate positive, negative and zero sequence.

To facilitate expressing converter control modes, the nodal voltage in the phase domain can be transformed into the sequence domain to be used according to Fortescue's symmetrical component decomposition:

$${E}_{l}^{+} = \frac{1}{3} ( {E}_{l}^{a} + α {E}_{l}^{b} + {α}^{2} {E}_{l}^{c} ) \qquad ( 9 )$$

$${E}_{l}^{-} = \frac{1}{3} ( {E}_{l}^{a} + {α}^{2} {E}_{i}^{b} + α {E}_{i}^{c} )$$

$${E}_{l}^{0} = \frac{1}{3} ( {E}_{l}^{a} + {E}_{l}^{b} + {E}_{l}^{c} )$$

where

$$α = {e}^{j \frac{2}{3} π} . {E}_{l}^{a} , {E}_{l}^{b} , {E}_{l}^{c}$$

are phase to where ground voltages on phases a, b, c of node l.

$${E}_{l}^{+} , {E}_{l}^{-} and {E}_{l}^{0}$$

are the positive, negative and zero sequence components of nodal voltage at node l.

If the converter (j, k) is operating at P_{ac}−Q_{ac} (i.e. PQ) mode, the converter's active and reactive power injections at AC side can be specified at positive and negative sequence, that is

$${P}_{l}^{+ *} , {P}_{l}^{- *} , {Q}_{l}^{+ *} , {Q}_{l}^{- *}$$

are given. Meanwhile, the zero sequence powers at AC side are zero which can be modelled by set

$${E}_{l}^{0 *}$$

as zero. The AC side of the VSC, which can inject positive and negative power references, is modelled as:

$${E}_{l}^{0 *} = \sqrt{{( \frac{1}{3} ( {E}_{l}^{a} + {E}_{l}^{b} + {E}_{l}^{c} ) )}^{2}} \qquad ( 10 )$$

$$Re ( {E}_{l}^{+} {\sum }_{n ∈ N} conj ( {Y}_{a c ( l , n )}^{+} {E}_{n}^{+} ) - {S}_{filter ( l , k )}^{+} - {S}_{loss ( l , k )}^{+} ) + {P}_{l}^{+ *} = {E}_{k} {\sum }_{m ∈ M} {Y}_{d c ( k , m )} {E}_{m}$$

$$Im ( {E}_{l}^{+} {\sum }_{n ∈ N} conj ( {Y}_{a c ( l , n )}^{+} {E}_{n}^{+} ) - {S}_{filter ( l , k )}^{+} - {S}_{loss ( l , k )}^{+} ) + {Q}_{l}^{+ *} = 0$$

$$Re ( {E}_{l}^{-} {\sum }_{n ∈ N} conj ( {Y}_{a c ( l , n )}^{-} {E}_{n}^{-} ) - {S}_{filter ( l , k )}^{-} - {S}_{loss ( l , k )}^{-} ) + {P}_{l}^{- *} = 0$$

$$Im ( {E}_{l}^{-} {\sum }_{n ∈ N} conj ( {Y}_{a c ( l , n )}^{-} {E}_{n}^{-} ) - {S}_{filter ( l , k )}^{-} - {S}_{loss ( l , k )}^{-} ) + {Q}_{l}^{- *} = 0$$

$$( j , k ) ∈ {Γ}_{PQ} \qquad ( 11 )$$

where

$${Y}_{a c ( l , n )}^{+} and {Y}_{a c ( l , n )}^{-}$$

are the elements of admittance matrices of positive-sequence AC network and negative-sequence AC network. If the converter only injects the positive sequence, the power balance of the negative sequence is ignored, and the voltage for negative sequence is set as by

$${E}_{l}^{- *} = 0 .$$

If the converter (j, k) is operating at P_{ac}−|E_{ac}| (i.e. PV) mode,

$${P}_{l}^{+ *} , {P}_{l}^{- *} , {E}_{l}^{{ϕ}_{{l}^{*}}}$$

are given. The AC side of the VSC can inject positive and negative power references. The interfacing VSC model consists of the following equations:

$${E}_{l}^{0 *} = \sqrt{{( \frac{1}{3} ( {E}_{l}^{a} + {E}_{l}^{b} + {E}_{l}^{c} ) )}^{2}}$$

$$Re ( {E}_{l}^{+} {\sum }_{n ∈ N} conj ( {Y}_{a c ( l , n )}^{+} {E}_{n}^{+} ) - {S}_{filter ( l , k )}^{+} - {S}_{loss ( l , k )}^{+} ) + {P}_{l}^{+ *} = {E}_{k} {\sum }_{m ∈ M} {Y}_{d c ( k , m )} {E}_{m}$$

$$Re ( {E}_{l}^{-} {\sum }_{n ∈ N} conj ( {Y}_{a c ( l , n )}^{-} {E}_{n}^{-} ) - {S}_{filter ( l , k )}^{-} - {S}_{loss ( l , k )}^{-} ) + {P}_{l}^{- *} = 0$$

$$for ( j , k ) ∈ {Γ}_{PV} \qquad ( 12 )$$

$$\vert {E}_{l}^{{ϕ}_{l}} \vert = \vert {E}_{l}^{{ϕ}_{l} *} \vert , for ( l , k ) ∈ {Γ}_{PV} , {ϕ}_{l} ∈ {Φ}_{l} \qquad ( 13 )$$

If the converter (j, k) is operating at E_{dc}−Q_{ac} (i.e. VQ) mode, the AC side reactive power injections at positive and negative sequences, and voltage at DC side are specified, that is

$${E}_{k}^{*} , {Q}_{l}^{+ *} , {Q}_{l}^{- *}$$

are given. To ensure zero homopolar components, set voltage of zero sequence

$${E}_{l}^{0 *} = 0 .$$

The reactive power setpoints at AC side are set as:

$${E}_{l}^{0 *} = \sqrt{{( \frac{1}{3} ( {E}_{l}^{a} + {E}_{l}^{b} + {E}_{l}^{c} ) )}^{2}}$$

$$Im ( {E}_{l}^{+} {\sum }_{n ∈ N} conj ( {Y}_{a c ( l , n )}^{+} {E}_{n}^{+} ) - {S}_{filter ( l , k )}^{+} - {S}_{loss ( l , k )}^{+} ) + {Q}_{l}^{+ *} = 0$$

$$Im ( {E}_{l}^{-} {\sum }_{n ∈ N} conj ( {Y}_{a c ( l , n )}^{-} {E}_{n}^{-} ) - {S}_{filter ( l , k )}^{-} - {S}_{loss ( l , k )}^{-} ) + {Q}_{l}^{- *} = 0$$

$$For ( j , k ) ∈ {Γ}_{{E}_{d c} Q} \qquad ( 14 )$$

The DC voltage setpoint is set as:

$${E}_{k}^{*} = - \frac{{\sum }_{m ∈ M , m \neq k} {Y}_{d c ( k , m )} {E}_{m}}{2 {Y}_{d c ( k , k )}} \pm \sqrt{{( \frac{{\sum }_{m ∈ M , m \neq k} {Y}_{d c ( k , m )} {E}_{m}}{2 {Y}_{d c ( k , k )}} )}^{2} + \frac{ℜ e ( {E}_{l}^{+} {\sum }_{n ∈ N} conj ( {Y}_{a c ( l , n )}^{+} E \text{?}}{{Y}_{d c} \text{?}}}$$

$$( j , k ) ∈ {Γ}_{{E}_{d c} Q} \qquad ( 15 )$$

$$\text{?} \text{indicates text missing or illegible when filed}$$

(15) is derived using the positive sequence active power balance equation at the interface converter in term of the DC voltage

$${E}_{k}^{*} ,$$

which can be expressed as:

$${{Y}_{d {c}_{( k , k )}} ( {E}_{k}^{*} )}^{2} + {\sum }_{m ∈ M , m ∉ k} {Y}_{d c ( k , m )} {E}_{m} {E}_{k}^{*} - Re ( {E}_{l}^{+} {\sum }_{n ∈ N} conj ( {Y}_{a c ( l , n )}^{+} {E}_{n}^{+} ) - {S}_{filter ( l , k )}^{+} - {S}_{loss ( l , k )}^{+} ) = 0.$$

Solving this quadratic equation results in two solutions for Ek, where the feasible solution is typically close to 1 p.u.

In compact form, the above power flow equations can be represented as:

$${F}^{*} = F ( X ) \qquad ( 16 )$$

Where X is the vector of state variables,

$$X = [ \begin{matrix}\vert E \vert \\ ∠ E\end{matrix} ] ,$$

|E| is the vector of magnitudes of phase node voltages or DC voltages, ∠E is the vector of phase angles of phase node. Generally speaking, the state variables include node voltages, branch currents, and branch power flows. Since all other variables can be derived from node voltages, the state variables typically refer solely to node voltages unless explicitly stated otherwise. Moreover, voltages can be expressed in both polar and rectangular coordinates. In this context, the processor formulates the power flow equations and respective solutions using polar coordinates as an example. F(X) is the vector of values for control variables calculated from the state variables X,

$$F ( X ) = [ \begin{matrix}P ( \vert E \vert , ∠ E ) \\ Q ( \vert E \vert , ∠ E ) \\ \vert E \vert ( \vert E \vert , ∠ E )\end{matrix} ] ,$$

P(|E|, ∠E) is the vector of phase and positive, negative sequence active power injections for AC and DC nodes, Q (|E|, ∠E) is the vector of phase and positive, negative sequence reactive power injections for AC nodes. |E|(|E|, ∠E) is the vector of phase and zero-sequence node voltage magnitudes of AC and DC nodes.

$${F}^{*} = [ \begin{matrix}{P}_{spec} \\ {Q}_{spec} \\ \vert {E}_{spec} \vert\end{matrix} ]$$

is the vector of setting points for control variables, including active power references P_{spec}, reactive references Q_{spec}, and voltage magnitude references |E_{spec}|.

Power systems are controlled by regulating the operating points of control variables to ensure stable system operation while avoiding violations of operational constraints. These constraints can be related to control variables, such as reactive power injections at AC nodes, or state variables, such as the nodal voltage magnitudes of both AC and DC nodes. Constraint violations can be mitigated by adjusting the setpoints for control variables or by modifying the control/regulation types of buses or converters.

Unified Solution Using Newton-Raphson with Hybrid Correction

To solve the power flow equations for the hybrid AC/DC network 100, the processor 310 applies the Newton-Raphson method with integrated prediction-correction, trust-region, and line search methods as follows.

### (1). Mismatch Vector Calculation.

The power and voltage mismatches across AC/DC buses and VSC-controlled nodes are calculated based on given values of state variables. The mismatch vector ΔF is defined as:

$$Δ F = [ \begin{matrix}Δ P \\ Δ Q \\ Δ \vert E \vert\end{matrix} ] = [ \begin{matrix}{P}_{spec} \\ {Q}_{spec} \\ \vert {E}_{spec} \vert\end{matrix} ] - [ \begin{matrix}P ( \vert E \vert , ∠ E ) \\ Q ( \vert E \vert , ∠ E ) \\ \vert E \vert ( \vert E \vert , ∠ E )\end{matrix} ] \qquad ( 17 )$$

Where ΔP is the vector of power mismatches at AC/DC nodes between specified values P_{spec}, and calculated values P(|E|, ∠E) based on the given values for state variables |E|, and ∠E. ΔQ is the vector of power mismatches at AC/DC nodes between specified values Q_{spec}, and calculated values Q(|E|, ∠E) based on given |E| and ∠E. Δ|E| is the vector of voltage mismatches at AC/DC nodes between specified values |E_{spec}|, and calculated values |E|(|E|, ∠E) based on given |E|, and ∠E.

### (2). Jacobian Matrix Construction.

Once the state variables X are determined, the processor constructs the Jacobian matrix/by computing the partial derivatives of the power flow equations with respect to voltage magnitudes and angles,

$$\frac{\partial F}{\partial X}$$

as follows:

$$\begin{matrix}J = \frac{Δ F}{Δ X} \\ = - \frac{\partial F}{\partial X} \\ = - \frac{\partial ( P , Q , \vert E \vert )}{\partial ( \vert E \vert , ∠ E )} \\ = - [ \begin{matrix}\frac{\partial P}{\partial ( \vert E \vert )} & \frac{\partial P}{\partial ( ∠ E )} \\ \frac{\partial Q}{\partial ( \vert E \vert )} & \frac{\partial Q}{\partial ( ∠ E )} \\ \frac{\partial ( \vert E \vert )}{\partial ( \vert E \vert )} & \frac{\partial ( \vert E \vert )}{\partial ( ∠ E )}\end{matrix} ]\end{matrix} \qquad ( 18 )$$

Where ΔX is the vector of updates of state variables:

$$Δ X = [ \begin{matrix}Δ \vert E \vert \\ Δ∠ E\end{matrix} ] \qquad ( 19 )$$

Δ|E| and Δ∠E are the updates for nodal voltage magnitudes and angles.

As shown in (18), the Jacobian submatrices for active and reactive power mismatches at AC buses are computed to accurately represent nodal power deviations. Additionally, voltage and power mismatches associated with VSCs under different control modes are incorporated to account for their dynamic interactions within the hybrid AC/DC network.

The Jacobian matrix is typically sparse. The Jacobian elements that relate power flow equations of AC buses to the voltages at DC nodes are usually zero, except at buses or nodes of converters, and vice versa. Even for Jacobian elements relating power flows between the same type of buses or nodes (e.g., AC buses), due to the limited connections between them, the Jacobian elements relating non-connected buses are generally zero as well.

3. Prediction of State Based on State Update Determined Using Newton-Raphson Method with Adaptative Step Size Control.

This predictor step determines an initial estimation of the system state update, ΔX_{pred} by solving the following linearized equation:

$$Δ {X}_{pred} = {J}^{- 1} Δ F \qquad ( 20 )$$

Where J⁻¹ is the inverse of Jacobian matrix.

The system state updated after the predictor step, X_{pred} are computed as:

$${X}_{pred} = X + δΔ {X}_{pred} \qquad ( 21 )$$

### 4. Adaptive Step Size Control.

Correcting predicted states using Preconditioned Conjugate Gradient method and The step size δ is adjusted based on mismatch norm ∥ΔF∥:

$$δ = \{ \begin{matrix}\frac{δ}{2} & if ‖ Δ F ‖ > ‖ Δ {F}_{old} ‖ \\ min \{ 2 δ , {δ}^{m ax} \} & otherwise\end{matrix} \qquad ( 22 )$$

Where ∥ΔF∥ represents the current mismatch norm, ∥Δ_{Fold}∥ is the previous mismatch norm, and Smax is the upper bound for the step size.

### 4. Correcting Predicted States Using Preconditioned Conjugate Gradient Method and Trust-Region Constraint.

This correction step determines an additional update for system state (i.e. state correction), ΔX_{corr} by solving the trust-Region subproblem using the Preconditioned Conjugate Gradient (PCG). The subproblem is defined as a combination of a linearized equation (23a) along with a trust region constraint (23b):

$$J Δ {X}_{corr} = Δ {F}_{pred} \qquad ( 23 a )$$

$$‖ Δ {X}_{corr} ‖ \leq {R}_{trust} \qquad ( 23 b )$$

Where Rₜᵣᵤₛₜ is the radius of Trust-region. ΔF_{pred} is the mismatches of state X_{pred} computed as:

$$Δ {F}_{pred} = {F}^{*} - F ( {X}_{pred} ) \qquad ( 24 )$$

The Preconditioned Conjugate Gradient method iteratively solve Equation (23) using adaptative preconditioning and adaptive search direction.

The search direction p and ΔX_{corr} are iteratively determined. The iteration process for PCG starts with setting initial state correction ΔX_{corr}, residual r and search direction p, and residual norm rs_{old}:

$$Δ {X}_{c o r r} = 0. \qquad ( 25 )$$

$$r = {J}^{T} Δ {F}_{pred} - {J}^{T} J Δ {X}_{c o r r} . \qquad ( 26 )$$

$$z = {M}^{- 1} r \qquad ( 27 )$$

$$p = z \qquad ( 28 )$$

$${rs}_{old} = {r}^{T} z \qquad ( 29 )$$

In equation (28), the projected residual is used to improve numerical stability for the ill-conditioned systems by multiplying the transpose of the Jacobian matrix to both the left and right-hand sides of the linearized equation (23).

For each iteration step, state correction ΔX_{corr} is updated using step size α computed as:

$$α = \frac{{r}^{T} z}{{p}^{T} {J}^{T} Jp} \qquad ( 30 )$$

$$Δ {X}_{c o r r} = Δ {X}_{c o r r} + α p \qquad ( 31 )$$

Then the latest ΔX_{corr} is checked with trust radius constraint to enforce the solution within the trust region boundary. After that, residual r is updated and new residual norm rs_{new} is determined:

$$r = r - α {J}^{T} Jp \qquad ( 32 )$$

$$z = {M}^{- 1} r \qquad ( 33 )$$

$$r {s}_{n e w} = {r}^{T} z \qquad ( 34 )$$

After rs_{new} is obtained, a residual convergence is checked. The PCG iteration converges, if residual norm \sqrt{rs_{new}} is lower than a given tolerance for conjugate gradient ∈_{cg} that indicates the mismatch has been sufficiently reduced. If the PCG iteration does not converges when maximum number conjugate gradient iteration n_{cg} is reached, a line search is performed instead to ensure sufficient reduction. Otherwise, compute new search direction and save residual norm to continue next iteration for PCG:

$$β = r {s}_{n e w} / r {s}_{old} . \qquad ( 35 )$$

$$p = z + β p \qquad ( 36 )$$

$$r {s}_{old} = r {s}_{new} \qquad ( 37 )$$

### 5. Adaptive Preconditioning.

The preconditioner is configured based on Jacobian condition number:

$${κ}_{J} = cond ( {J}^{T} J ) \qquad ( 38 )$$

Where K_{J} represents the condition number of the squared Jacobin matrix. To improve numerical stability, the inversee of the preconditioner matrix is computed as:

$${M}^{- 1} = \{ \begin{matrix}diag ( \frac{1}{diag ( {J}^{T} J ) + {ϵ}_{cond}} ) & if {κ}_{J} \geq τ \\ diag ( \frac{1}{diag ( {J}^{T} J )} ) & otherwise\end{matrix} , \qquad ( 39 )$$

where M is the preconditioner matrix to improve the conditioning of the system. ∈_{cond} is a small regularization factor to prevent division by near-zero values. τ is a predefined threshold (e.g., 10¹²) to determine when regularization is needed.

### 6. Trust Region Constraint Check and Solution Scaling Back.

When the processor gets a solution for ΔX_{corr}, a Trust-Region Constraint defined in (23b) will be checked to ensure that the update remains within a bounded region. If the correction step violates the trust-region constraint, the correction step is scaled back:

$$Δ {X}_{c o r r} = Δ {X}_{c o r r} \frac{{R}_{t r u s t}}{‖ Δ {X}_{c o r r} ‖} \qquad ( 40 )$$

7. Line Search to Determine State Correction when PCG Step Fails.

If PCG correction step does not sufficiently reduce the mismatch, a line search with given search direction p and initial state correction ΔX_{corr} is performed to iteratively adjust the step size and state correction. The update is computed as:

$$Δ {X}_{c o r r} = Δ {X}_{c o r r} + β p \qquad ( 41 )$$

where step size β is adjusted based on the Armijo condition i.e. sufficient decrease condition to be satisfied:

$$\frac{1}{2} {‖ J Δ {X}_{c o r r} ‖}^{2} - {( Δ {F}_{pred} )}^{T} Δ {X}_{c o r r} \leq c β {‖ p ‖}^{2} \qquad ( 42 )$$

Where c is sufficient decrease parameter (such as 0.0001). If the condition is not met, β is updated using backtracking:

$$β = ϛβ , 0 < ϛ < 1 \qquad ( 43 )$$

Where [symbol] is reduction factor (such as 0.5). If the condition is met, the iteration process for line search stops.

### 8. Combination of Prediction and Correction Steps.

After getting the state correction ΔX_{corr}, the processor combines the state correction ΔX_{corr} with the determined state prediction X_{pred} to get a solution for system state, i.e. voltages, X_{combined} as:

$${X}_{combined} = {X}_{pred} + δΔ {X}_{corr} \qquad ( 44 )$$

A trust region is adjusted according to the successfulness of the updated state X_{combined}

### 9. Trust Region Adaptation

A Trust-Region Adaptation is performed based on the effectiveness of state correction. The effectiveness of the correction step is evaluated using the ratio of actual to predicted reduction, ρ:

$$ρ = \frac{‖ Δ F ‖ - ‖ Δ {F}_{c o m b i n e d} ‖}{‖ Δ {F}_{p r e d} ‖} \qquad ( 45 a )$$

ΔF_{combined} is the vector of mismatches calculated using X_{combined}, ΔF_{combined}=F*−F(X_{combined}). If ∥ΔF∥ is not available due to lack of initial state, the effectiveness can be defined as:

$$ρ = \frac{‖ Δ {F}_{pred} ‖ - ‖ Δ {F}_{c o m b i n e d} ‖}{‖ Δ {F}_{p r e d} ‖} \qquad ( 45 b )$$

Based on the computed value of ρ, the trust-region radius is updated dynamically as:

$${R}_{trust} = \{ \begin{matrix}min \{ 2 {R}_{trust} , {δ}^{m ax} \} & if ρ > η \\ {R}_{trust} / 2 & otherwise\end{matrix} \qquad ( 46 )$$

Where η is the acceptance threshold. If the correction step fails to improve the solution (ρ≤η), the step is rejected, and the trust-region radius is reduced to ensure better control in subsequent iterations.

### 10. Convergence Check and Iteration Update

When a system state X, such as X_{pred} or X_{combined} is obtained, a convergence check is needed to determine if the power flow solution is converged, or more iterations are required. The check is based on the mismatch norm ∥ΔF∥, and ΔF=F*−F(X).

If the mismatch norm ∥ΔF∥ is below a specified tolerance ∈ₜₒₗ, ∥ΔF∥<∈ₜₒₗ and iterations have not reached a given maximum number, then the power flow is converged and power flow solution is completed. Otherwise, the power flow continues to next iteration.

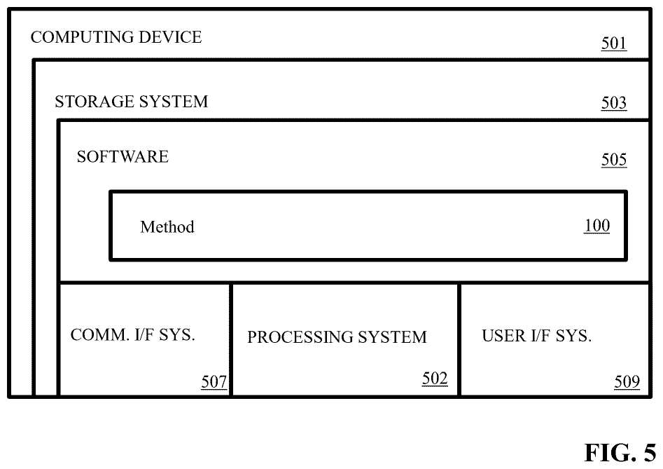

FIG. 5 shows a schematic of a system 501, for example, computing device 501 that is representative of any system or collection of systems in which the various processes, programs, services, and scenarios of some embodiments disclosed herein are implemented. Examples of computing device 501 include, but are not limited to, desktop and laptop computers, tablet computers, mobile computers, server computers, web servers, cloud computing platforms, and data center equipment, as well as any other type of physical or virtual server machine, container, and any variation or combination thereof.

Computing device 501 may be implemented as a single apparatus, system, or device or may be implemented in a distributed manner as multiple apparatuses, systems, or devices. Computing device 501 includes, but is not limited to, processing system 502, storage system 503, software 505, communication interface system 507, and user interface system 509. Processing system 502 is operatively coupled with storage system 503, communication interface system 507, and user interface system 509.

Processing system 502 loads and executes software 505 from storage system 503. Software 505 includes and implements principles of method, for example method 100 and method 200, described in various exemplar embodiments. When executed by processing system 502, software 505 directs processing system 502 to operate as described herein for at least the various processes, operational scenarios, and sequences discussed in the foregoing implementations. Computing device/controller 501 may optionally include additional devices, features, or functionality not discussed for purposes of brevity, control various parameters of a hybrid AC/DC power system as per the method 100 described above.

Referring still to FIG. 5, processing system 502 may comprise a micro-processor and other circuitry that retrieves and executes software 505 from storage system 503. Processing system 502 may be implemented within a single processing device but may also be distributed across multiple processing devices or sub-systems that cooperate in executing program instructions. Examples of processing system 502 include general purpose central processing units, graphical processing units, digital signal processors, application specific processors, and logic devices, as well as any other type of processing device, combinations, or variations thereof.

Storage system 503 may comprise any computer readable storage media readable by processing system 502 and capable of storing software 505. Storage system 503 may include volatile and nonvolatile, removable and non-removable media/memory implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 503 may also include computer readable communication media over which at least some of software 505 may be communicated internally or externally. Storage system 503 may be implemented as a single storage device but may also be implemented across multiple storage devices or sub-systems co-located or distributed relative to each other. Storage system 503 may comprise additional elements, such as a controller, capable of communicating with processing system 502 or possibly other systems.

Software 505 (the method 100, or any other method described in the present disclosure) may be implemented in program instructions and among other functions may, when executed by processing system 502, direct processing system 502 to operate as described with respect to the various operational scenarios, sequences, frameworks, and processes illustrated and/or discussed herein. For example, software 505 may include program instructions for implementing Newton-Raphson method, PCH method with trust region, and line search method discussed herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 505 may include additional processes, programs, or components, such as operating system software, virtualization software, or other application software. Software 505 may also comprise firmware or some other form of machine-readable processing instructions executable by processing system 502.

In general, software 505 may, when loaded into processing system 502 and executed, transform a suitable apparatus, system, or device (of which computing device 501 is representative) overall from a general-purpose computing system into a special-purpose computing system customized to perform computer vision processes in an optimized manner. Indeed, encoding software 505 on storage system 503 may transform the physical structure of storage system 503. The specific transformation of the physical structure may depend on various factors in different implementations of this description. Examples of such factors may include, but are not limited to, the technology used to implement the storage media of storage system 503 and whether the computer-storage media are characterized as primary or secondary storage, as well as other factors.

For example, if the computer readable storage media are implemented as semiconductor-based memory, software 505 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 507 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 501 and other computing systems, may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

### Case Study

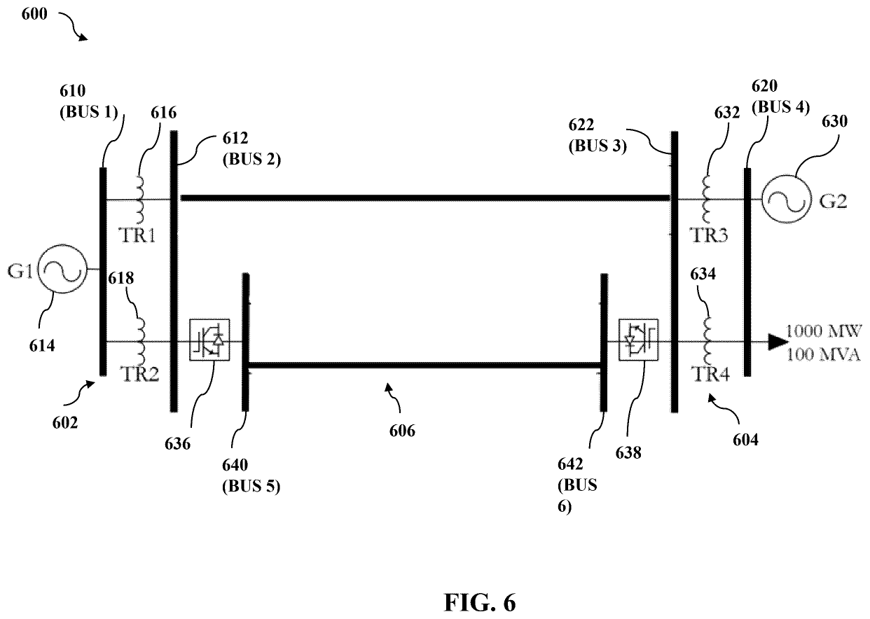

To evaluate the performance and robustness of the proposed method, a test system 600, as depicted in FIG. 6, is employed. The system 600 is a small-scale hybrid grid, with a variety of operational conditions, control schemes, and converter limits, allowing for a thorough assessment of the present method for power flow analysis and associated control of the system under real-world conditions. The chosen system also demonstrates the present method for power flow analysis and the associated controller's ability to handle unbalanced loads, ill-conditioned scenarios, and hybrid control modes involving both AC and DC components.

FIG. 6 shows a 6-Bus HVDC System 600. As illustrated in FIG. 6, the system 600 comprises two AC networks, a first AC network 602 and a second AC network 604, connected by a DC transmission line 606. The first AC network includes buses 610 (BUS 1) and 612 (BUS 2), with bus 610 linked to a generator 614 via a transformers 616, 618. On the other side, the second AC network 604 contains buses 620 (BUS 4) and 622 (BUS 3), with bus 620 connected to a 1000 MW load and a generator 630 through transformers 632, 634. The AC and DC networks are interfaced through Voltage Source Converters (VSCs), for example, a first VSC 636 at bus 640 (BUS 5) and a second VSC 638 at bus 642 (BUS 6). These VSCs 636, 638 operate in both PQ and VQ control modes, regulating power transfer between the AC and DC systems.

In the systems, strict operational limits are enforced on the converters. PQ-controlled converters are limited in both active and reactive power flows, ensuring that these parameters remain within defined boundaries. For VQ-controlled converters, voltage setpoints are tightly regulated to maintain system stability. These limits replicate the challenges of real-world grid management, such as heavy loading, large voltage deviations, and the need to manage power flow across both AC and DC systems.

The system 600 illustrates the flexibility and robustness of the present method for performing power flow analysis, showcasing its ability to manage complex, unbalanced, and ill-conditioned scenarios while maintaining high performance in hybrid AC/DC systems.

The invented method 100, 200 which combines adaptive trust-region strategies, conjugate gradient methods, prediction-correction frameworks, and dynamic line search, is evaluated against the Benchmark Method (standard Newton-Raphson). Each method is tested on both balanced and unbalanced systems across various scenarios, including grid stress and operational limit violations, to compare convergence speed, robustness, and computational efficiency.

The invented method is also called as AHPC-TRDLS method which stands for a Adaptive Hybrid Prediction-Correction method with Trust-Region and Dynamic Line Search.

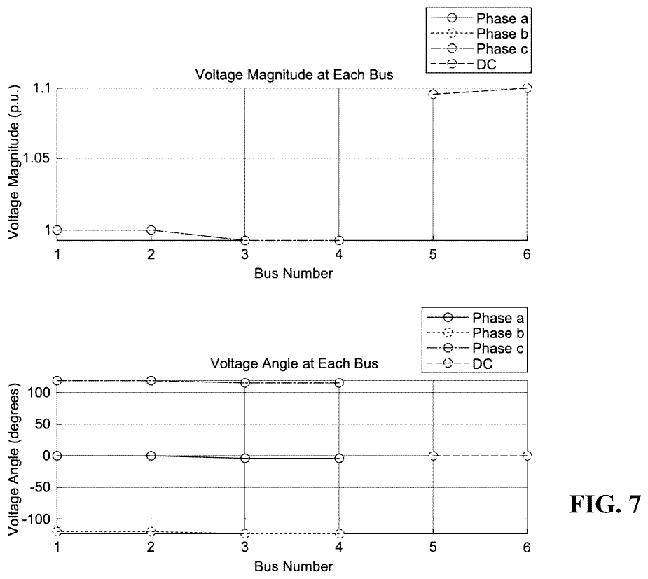

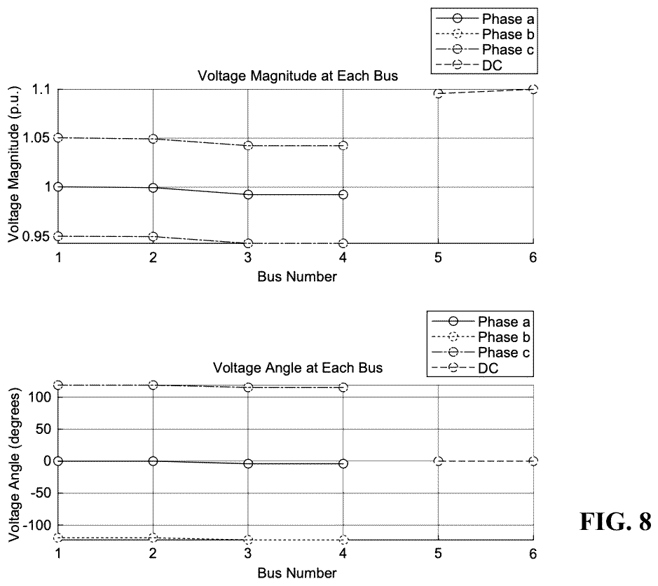

Table 1 compares the performance of two different methods under balanced and unbalanced conditions for the system 600. The table 1 focuses on the number of iterations required to converge and the execution time in seconds. FIG. 7 and FIG. 8 shows schematics of bus voltages of the system 600 determined under balanced and unbalanced conditions using the proposed method 100, 200 (AHPC-TRDLS).

TABLE 1
Balanced and unbalanced system performance for the system 600

| | Type of System | | | |
|---|---|---|---|---|
| | Balanced | | Unbalanced | |
| | Method | | | |
| | No. of | Execution | No. of | Execution |
| | Iteration | Time (sec) | Iteration | Time (sec) |
| Newton-Raphson (NR) | 10 | 0.1933 | 9 | 0.1835 |
| AHPC-TRDLS | 9 | 0.1796 | 9 | 0.1802 |

Benchmark Method (i.e. NR) serves as the baseline for comparison. Benchmark Method (i.e. NR) shows a moderate performance with 10 iterations and 0.1933 seconds for a balanced system and slightly fewer iterations (9) and a slightly faster time (0.1835 seconds) for the unbalanced system. AHPC-TRDLS demonstrates the better performance in terms of both iterations and execution time. AHPC-TRDLS converges in 9 iterations for both systems, with marginally different execution times. The AHPC-TRDLS method outperforms traditional method in terms of both speed and convergence. The method is effective in both balanced and unbalanced systems, where the number of iterations and execution times are similar, suggesting that they handle the inherent complexities of hybrid AC/DC networks more efficiently.

Table 2 focuses on the performance of the methods in systems where there is a significant difference in the line parameters (G and B) for the system 600.

TABLE 2
Performance with Large Differences in Parameters for system 600

| | Type of System | | | |
|---|---|---|---|---|
| | Balanced | | Unbalanced | |
| | Method | | | |
| | No. of | Execution | No. of | Execution |
| | Iteration | Time (sec) | Iteration | Time (sec) |
| Newton-Raphson (NR) | 64 | 0.3556 | 62 | 0.2944 |
| AHPC-TRDLS | 46 | 0.2467 | 41 | 0.2185 |

As shown in Table 2, the benchmark method shows a drastic increase in iterations (64) and execution time (0.3556 seconds) in the balanced case and similar values in the unbalanced case. This indicates that benchmark method struggles with large parameter differences. AHPC-TRDLS method maintains its superiority, with significantly fewer iterations (46) and faster execution times. AHPC-TRDLS handles the large differences efficiently, with the fastest execution time of 0.2467 seconds in the balanced case. The results indicate that AHPC-TRDLS method with adaptive preconditioning is better equipped to handle systems with large differences in parameters. Traditional method either struggles with convergence or requires a high number of iterations. This highlights the importance of advanced methods in ensuring scalability and robustness in complex systems.

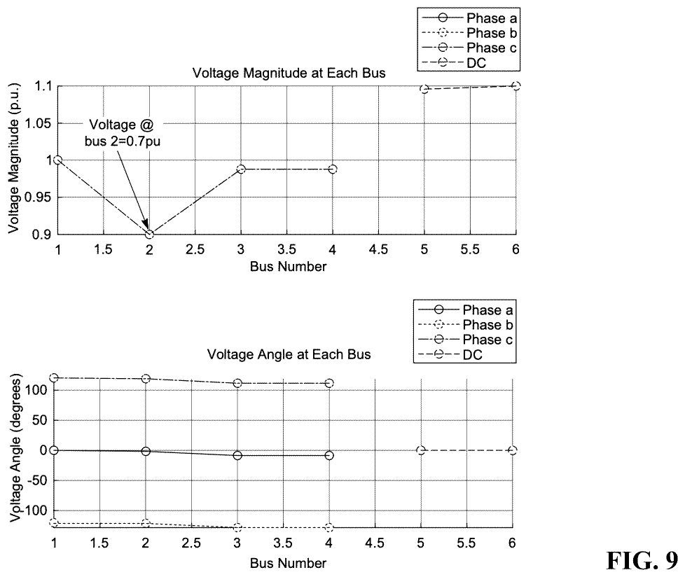

The voltage and reactive power limit assessment for the system 600 demonstrates varying performance across methods as shown in Table 3. FIG. 9 shows a schematic of bus voltages of the system 600 under condition with one bus voltage fallen below lower threshold by using the proposed AHPC-TRDLS method.

The benchmark method completes the task with 30 to 35 iterations, but with higher execution times, indicating potential inefficiencies. In contrast, AHPC-TRDLS maintains efficient performance with lower iteration counts (32 and 35) and shorter execution times, highlighting its robustness and suitability for managing voltage and reactive power constraints efficiently.

TABLE 3
Voltage and Reactive Power Limit Assessment for the system 600

| | Type of System | | | |
|---|---|---|---|---|
| | Voltage below V-limit | | Q-limit exceeded | |
| | Method | | | |
| | No. of | Execution | No. of | Execution |
| | Iteration | Time (sec) | Iteration | Time (sec) |
| Newton-Raphson (NR) | 30 | 0.2821 | 35 | 0.3757 |
| AHPC-TRDLS | 32 | 0.2417 | 35 | 0.2648 |

Table 4 focuses on the system 600 performance under weak grid conditions, where the network has a low X/R ratio (<1) and is more prone to instability. As shown in Table 4, the benchmark method struggles in weak grid conditions, with 12 iterations in the balanced case and failure to converge in the unbalanced case. The AHPC-TRDLS method shows excellent performance under weak grid conditions, converging in fewer iterations (7) with efficient execution times. AHPC-TRDLS performs well in the unbalanced case, with the fastest execution time of 0.2195 seconds. Weak grid conditions are a challenge for the traditional method, but AHPC-TRDLS maintains resilience and convergence under these conditions. This demonstrates its robustness in low X/R ratio scenarios, which are critical in modern grids with high penetration of renewable energy and distributed generation.

TABLE 4
Weak Grid Conditions for the system 600

| | Type of System | | | |
|---|---|---|---|---|
| | Balanced | | Unbalanced | |
| | Method | | | |
| | No. of | Execution | No. of | Execution |
| | Iteration | Time (sec) | Iteration | Time (sec) |
| Newton-Raphson (NR) | 12 | 0.2205 | Not | — |
| | | | Converged | |
| AHPC-TRDLS | 7 | 0.1848 | 10 | 0.2195 |

Table 5 examines how random perturbations in system parameters (G and B) affect method performance in both balanced and unbalanced systems. For the system 600, the benchmark method performs slightly worse in the presence of randomness, with longer execution times in both balanced (0.1927 seconds) and unbalanced (0.1810 seconds) conditions. AHPC-TRDLS method shows robustness against randomness, maintaining a low number of iterations (9) and fast execution times (0.1816 seconds for balanced and 0.1815 seconds for unbalanced). The inclusion of randomness reveals that robust methods like AHPC-TRDLS are not significantly impacted by small perturbations, unlike traditional methods. This resilience is critical in real-world systems, where small, random variations in parameters are common due to environmental or operational fluctuations.

TABLE 5
Evaluation of the system 600 on Balanced vs
Unbalanced Load Flow with Random Variability

| | Type of System | | | |
|---|---|---|---|---|
| | Balanced | | Unbalanced | |
| | Method | | | |
| | No. of | Execution | No. of | Execution |
| | Iteration | Time (sec) | Iteration | Time (sec) |
| Newton-Raphson (NR) | 10 | 0.1927 | 9 | 0.181 |
| AHPC-TRDLS | 9 | 0.1816 | 8 | 0.1815 |

In summary, the invented AHPC-TRDLS method provides an efficient and robust solution for power flow analysis in modern hybrid AC/DC power systems. By integrating adaptive preconditioning, trust-region methods, and dynamic line search, this method addresses the unique challenges posed by hybrid grids that feature VSCs, HVDC links, and unbalanced, multi-phase systems. Through extensive testing, the AHPC-TRDLS method has demonstrated superior convergence behavior and accuracy, particularly in complex grid scenarios involving operational limits and high system stress. In applications to hybrid HVDC systems, such as test system 600, the AHPC-TRDLS method consistently performed well under balanced and unbalanced conditions. The method effectively handled unbalanced scenarios, such as when phase voltages differed significantly or power flow varied. AHPC-TRDLS method maintained system stability and accuracy despite randomness and large differences in line parameters (G and B), showing resilience even in weakly connected grids with high impedance. This demonstrates the method's robustness and adaptability for managing real-world power grids with varying degrees of system stress and operational complexity. The method's capacity to handle weak grid scenarios was validated by simulating high impedance lines and weak connections, proving the AHPC-TRDLS method's effectiveness in challenging grid environments. This adaptability underscores its potential to improve load flow analysis in a variety of grid configurations, enhancing both accuracy and system stability.

1. A method for performing power flow analysis in a hybrid AC/DC power system, comprising:
linearizing nonlinear power flow equations of the hybrid AC/DC power system using a Newton-Raphson (NR) method to generate a sparse Jacobian matrix, a mismatch vector and a set of initial state variables;
iteratively solving the linearized equations using a Preconditioned Conjugate Gradient (PCG) method, wherein: the PCG method leverages the sparsity of the Jacobian matrix to compute updates to state variables; and a preconditioner is applied to improve the numerical stability and convergence of the PCG method;
refining the solution iteratively by feeding the updated state variables back into the NR method until convergence criteria are met to produce a result of the power flow analysis; and
controlling the power system based on the result of the power flow analysis.

2. The method of claim 1, further comprising:
dynamically switching to an alternative solving technique, including a line search method, if the PCG method fails to converge within a specified iteration limit, or mismatch reduction is less than a threshold.

3. The method of claim 1, wherein the power system comprises hybrid AC/DC networks, and the method further comprises:
modeling the interactions between AC and DC subsystems using the Jacobian matrix, incorporating voltage source converter (VSC) control modes.

4. The method of claim 1, wherein the preconditioner is selected from the group including one or a combination of a Jacobi preconditioner that uses diagonal elements of the Jacobian matrix, and an incomplete LU factorization.

5. The method of claim 4, wherein a preconditioner matrix, M is configured based on a condition number of a squared Jacobian matrix, J^{T}J, J is Jacobian matrix;
wherein the preconditioner matrix is a diagonal matrix defined using the diagonals of J^{T}J, diag(J^{T}J), if the condition number is less than a threshold, such that:
$${M}^{- 1} = diag ( \frac{1}{diag ( {J}^{T} J )} ) ;$$
otherwise, the inverse of preconditioner matrix M⁻¹ is adjusted with a small number ∈ to improve conditioning, such that:
$${M}^{Inv} = diag ( \frac{1}{diag ( {J}^{T} J ) + ϵ} ) .$$

6. The method of claim 1, further comprising:
decomposing unbalanced three-phase voltages and currents into symmetrical components and independently solving the positive, negative, and zero sequences using the combined NR and PCG framework.

7. The method of claim 1, wherein the convergence criteria include:
a threshold for the mismatch vector norm and operational constraints such as voltage magnitude limits and reactive power bounds.

8. The method of claim 2, wherein the line search method dynamically adjusts the step size to maintain convergence under ill-conditioned or highly stressed grid conditions.

9. The method of claim 1, wherein updates to the state variables, computed using the PCG method, are checked against a trust region constraint to ensure that the updates remain within a bounded region, wherein the trust-region constraint is represented by the norm of the updates to the state variables being less than a radius of the trust region.

10. The method of claim 9, wherein the updates to state variables are scaled back using a scaling factor if the constraint is violated.

11. The method of claim 9, wherein the radius of the trust region is updated based on the effectiveness index of updates to state variables determined using PCG method.

12. A system for performing power flow analysis in a power system, comprising:
a processor configured to execute instructions to: (i) linearize nonlinear power flow equations and finding an initial state using a Newton-Raphson (NR) method; (ii) solve the linearized equations using a Preconditioned Conjugate Gradient (PCG) method with a preconditioner; and (iii) dynamically switch to a line search method if the PCG method fails to converge; and
a memory storing instructions and parameters for the NR and PCG methods, including preconditioner definitions, convergence thresholds, and system topology information; and
a controller configured to control the power system based on the power flow analysis and using the instructions and parameters stored in the memory.

13. The system of claim 12, wherein the processor is further configured to execute instructions to
dynamically switch to an alternative solving technique, including a line search method, if the PCG method fails to converge within a specified iteration limit, or mismatch reduction is less than a threshold.

14. The system of claim 12, wherein the power system comprises hybrid AC/DC networks, and the processor is further configured to execute instructions to:
model the interactions between AC and DC subsystems using the Jacobian matrix, incorporating voltage source converter (VSC) control modes.

15. The system of claim 11, wherein the preconditioner is selected from the group including one or a combination of a Jacobi preconditioner that uses diagonal elements of the Jacobian matrix, and an incomplete LU factorization.

16. The system of claim 15, wherein a preconditioner matrix, M is configured based on a condition number of a squared Jacobian matrix, J^{T}J, J is Jacobian matrix; wherein the preconditioner matrix is a diagonal matrix defined using the diagonals of J^{T}J, diag(J^{T}J), if the condition number is less than a threshold, such that:
$${M}^{- 1} = diag ( \frac{1}{diag ( {J}^{T} J )} ) ;$$
otherwise, the inverse of preconditioner matrix M⁻¹ is adjusted with a small number ∈ to improve conditioning, such that:
$${M}^{Inv} = diag ( \frac{1}{diag ( {J}^{T} J ) + ϵ} ) .$$

17. The system of claim 12, wherein the processor is further configured to execute instructions to
decompose unbalanced three-phase voltages and currents into symmetrical components and independently solving the positive, negative, and zero sequences using the combined NR and PCG framework.

18. The system of claim 12, wherein the convergence criteria include:
a threshold for the mismatch vector norm and operational constraints such as voltage magnitude limits and reactive power bounds.

19. The system of claim 12, wherein the line search method dynamically adjusts the step size to maintain convergence under ill-conditioned or highly stressed grid conditions.

20. The system of claim 12, wherein updates to the state variables, computed using the PCG method, are checked against a trust region constraint to ensure that the updates remain within a bounded region, wherein the trust-region constraint is represented by the norm of the updates to the state variables being less than a radius of the trust region.
